(19) United States
(12) Patent Application Publication
(10) Pub. No.: US 2018/0049438 A1
(43) Pub. Date: Feb. 22, 2018

(54) NITRIFICATION INHIBITOR COMPOSITIONS AND METHODS FOR PREPARING THE SAME

(71) Applicant: DOW AGROSCIENCES LLC, Indianapolis, IN (US)

(72) Inventors: Hiteshkumar DAVE, Collegeville, PA (US); Melissa HAYS, Midland, MI (US); Lei LIU, JR., Indianapolis, IN (US); Holger TANK, Shanghai (CN)

(21) Appl. No.: 15/540,825

(22) PCT Filed: Dec. 23, 2015
(86) PCT No.: PCT/US15/00207

§ 371 Date: Jun. 29, 2017

Related U.S. Application Data
(60) Provisional application No. 62/098,961, filed on Dec. 31, 2014.

(51) Int. Cl. A01N 43/40; A01N 25/02

(52) U.S. Cl. CPC A01N 43/40; A01N 25/02

(57) ABSTRACT

The present disclosure relates the enhanced nitrification inhibitor compositions, methods for making the same, and their use in agricultural applications.

### CROSS REFERENCE TO RELATED APPLICATION

This application claims priority to U.S. Provisional Patent Application Ser. No. 62/098,961, filed Dec. 31, 2014, the disclosure of which is hereby expressly incorporated by reference herein in its entirety.

### FIELD OF THE INVENTION

The present disclosure relates to compositions that inhibit nitrification and methods of making the same.

### BACKGROUND AND SUMMARY

Nitrogen fertilizer added to the soil is readily transformed through a number of undesirable biological and chemical processes, including nitrification, leaching, and evaporation. Many transformation processes reduce the level of nitrogen available for uptake by the targeted plant. One such process is nitrification, a process by which certain widely occurring soil bacteria metabolize the ammonium form of nitrogen in the soil, transforming the nitrogen into nitrite and nitrate forms, which are more susceptible to nitrogen loss through leaching or volatilization via denitrification.

The decrease in available nitrogen due to nitrification necessitates the addition of more nitrogen rich fertilizer to compensate for the loss of agriculturally active nitrogen available to the plants. These concerns intensify the demand for improved management of nitrogen, in order to reduce costs associated With the use of additional nitrogen fertilizer.

Methods for reducing nitrification include treating soil with agriculturally active compounds that inhibit or at least reduce fee metabolic activity of at least some microbes in the soil that contribute to nitrification. These compounds include (trichloromethyl)pyridines, such as nitrapyrin, which have been used as nitrification inhibitors in combination with fertilizers as described in U.S. Pat. No. 3,135,594, the disclosure of which is incorporated herein by reference in its entirety. These compounds help to maintain agriculturally-applied ammonium nitrogen in the ammonium form (stabilized nitrogen), thereby enhancing plant growth, and crop yield. These compounds have been used efficaciously with a number of plant crops including corn, sorghum, and wheat.

The present disclosure relates to agricultural formulations comprising non-aromatic, water-soluble, polar solvents and one or more nitrification inhibitors, which improve the efficiency and application of the formulated product and, in some embodiments, allow more concentrated formulations to be prepared. When liquid formulations containing one or more nitrification inhibitors, such as nitrapyrin, and one or more polar solvents are diluted in water, the one or more nitrification inhibitors tend to crystallize in the system due to the polar solvent migrating into the aqueous phase.

Crystallization of nitrification, inhibitors leads to a number of problems, such as reduced biological efficacy and clogged spray nozzles during application to a field or crop. Therefore, in some embodiments, this disclosure further relates to identification of potential crystal growth inhibitors (crystallization inhibiting additives) for use in nitrapyrin formulations containing a polar solvent, which could prevent crystallization and/or inhibit or reduce crystal growth of the nitrification inhibitor (“NI”) once the formulation is diluted with an aqueous phase. In some embodiments, the additives are effective at preventing and/or inhibiting or reducing crystal formation for at least 24 hours after dilution of the polar solvent/nitrification inhibitor mixture into water or aqueous solvent.

While considerable progress has been made in the delivery and stability of nitrification inhibitors such as nitrapyrin, there remains a need for still more concentrated or higher load formulations containing compounds such as (trichloromethyl)pyridines.

Therefore, in a first embodiment, disclosed herein is an agricultural formulation, comprising at least one non-aromatic, polar solvent at least one inhibitor of nitrification, wherein the at least one inhibitor of nitrification is substantially dissolved in the at least one non-aromatic, polar solvent, and at least one crystallization inhibiting additive, wherein the crystallization inhibiting additive inhibits or reduces crystallization of the at least one inhibitor of nitrification when the formulation is added to water. Inhibits or inhibiting, as used herein, refers to a reduction in the amount of crystals formed of the at least one inhibitor of nitrification when the formulation is added to water, such as, about 10% or less, about 20% or less, about 30% or less, about 40% or less, about 50% or less, about 60% or less, about 70% or less, about 80% or less, about 90% or less, or about 100% or less reduction in the amount of crystals formed when compared to a formulation containing no crystallization inhibiting additive.

In a second embodiment, an aqueous composition containing the components of the formulation is formed when the formulation of the first embodiment is diluted in water.

In a third embodiment, the at least one non-aromatic, polar solvent of any of the preceding embodiments comprises a glycol ether such as, but not limited to dipropylene glycol monomethyl ether (Dowanol DPM; Dow Chemical)), propylene carbonate (Jeffsol AG 1555; Huntsman) or methyl 5-(dimethylamino)-2-methyl-5-oxopentanoate (DV-Solve 1059; Rhodia),

In a fourth embodiment, the at least one inhibitor of nitrification of any of the preceding embodiments comprises nitrapyrin.

In a fifth-embodiment, the nitrapyrin of any of the preceding embodiments is between about 0.1 wt. % and about 50 wt. % of the formulation.

In a sixth embodiment, the nitrapyrin of any of the preceding embodiments is between about 30 wt. % and about 40 wt. % of the formulation.

In a seventh embodiment, the at least one inhibitor of nitrification of any of the preceding embodiments comprises nitrapyrin.

In an eighth embodiment, the nitrapyrin of any of the preceding embodiments is between about 0.1 wt. % and about 5 wt. % of an aqueous composition when the formulation is dilated in water.

In a ninth embodiment, the nitrapyrin of any of the preceding embodiments is between about 0.4 wt. % and about 4 wt. % of the aqueous composition when the formulation is diluted in water.

In a tenth embodiment, the at least one crystallization inhibiting additive of any of the preceding embodiments comprises a polymer substantially dissolved in the at least one non-aromatic, polar solvent.

In an eleventh embodiment the polymer of any of the preceding embodiments comprises a homopolymer of 1-ethenyl-2-pyrrolidionone.

In a twelfth embodiment, the at least one crystallization inhibiting additive of any of the preceding embodiments is selected from the group consisting of: homopolymers of 1-ethenyl-2-pyrrolidinone; ethoxylated triglycerides, and polycarboxylat polymers.

In a thirteenth embodiment, the at least one crystallization inhibiting additive of any of the preceding embodiments is selected from the group consisting of: alpha-cyclodextin; polyethylene glycols and ethers thereof salts of polycarboxylic acids, sodium salts of lignosulfonate acids, alkali lignin reaction products with disodium sulfite and formaldehyde, acrylic copolymers, alcohol initiated EO-BO polymers, sodium arylsulfonates, fatty acids, polyarylphenol alkoxylates, vinyl acetate homopolymers, seed oils, sodium alkylaminopropionates, poly(4-ammonium styrene sulfonic acid), pigmentary synergist agents for dispersants, alkoxylated diamines, alcohol ethoxylates and polyoxyethylene sorbitan monofatty acids.

In a fourteenth embodiment, the at least one crystallization inhibiting additive of any of the preceding embodiments is present in at least about 1, 2, 3, 4, 5, 6, 7, 8, 9, or 10 wt. % in the formulation, more specifically between about 2 wt. % and about 8 wt. %.

In a fifteenth embodiment the at least one crystallization inhibiting additive of any of the preceding embodiments is present in at least about 0.1, 0.2, 0.3, 0.4, 0.5, 0.6, 0.7, 0.8, 0.9, or 1.0 wt. % in a water diluted formulation, more specifically between about 0.2 wt. % and about 0.8 wt. %.

In a sixteenth embodiment, a method is disclosed for inhibiting or reducing crystal formation of at least one inhibitor of nitrification, comprising the step of adding at least one crystallization inhibiting additive to a formulation comprising at least one non-aromatic, polar solvent and at least one inhibitor of nitrification, wherein said at least one inhibitor of nitrification is substantially dissolved in the at least one non-aromatic, polar solvent, wherein the crystallization inhibiting additive reduces or inhibits crystallization of the at least one inhibitor of nitrification when the formulation is added to or diluted in water. In some embodiments, the method further comprises the step of diluting the formulation by addition of an aqueous phase to the formulation.

In seventeenth embodiment, the at least one non-aromatic, polar solvent of any of the preceding embodiments comprises a glycol ether such as, but not limited to dipropylene glycol monomethyl ether (Dowanol DPM; Dow Chemical)), propylene carbonate (Jeffsol AG 1555; Huntsman) or methyl 5-(dimethylamino-2-methyl-5-oxopentanoate (DV-Solve 1059; Rhodia).

In an eighteenth embodiment, the at least one inhibitor of nitrification of any of the preceding embodiments comprises nitrapyrin.

In a nineteenth embodiment, the nitrapyrin of any of the preceding embodiments is between about 0.1 wt. % and about 50 wt. % of the formulation.

In a twentieth embodiment the nitrapyrin of any of the preceding embodiments is between about 30 wt. %: and about 40 wt. % of the formulation.

In a twenty-first embodiment, the formulation of any of the preceding embodiments is diluted in water to between about 0.1 wt. % and about 5 wt. % of nitrapyrin.

In a twenty-second embodiment, the formulation of any of the preceding embodiments is diluted in water to between about 0.4 wt. % and about 4 wt. % of nitrapyrin.

In a twenty-third embodiment, the at least one crystallization inhibiting additive of any of the preceding embodiments comprises a polymer substantially dissolved in the at least one non-aromatic, polar solvent.

In a twenty-fourth embodiment, the polymer of any of the preceding embodiments comprises homopolymers of 1-ethenyl-2-pyrrolidinone.

In a twenty-fifth embodiment, the crystallization inhibiting additive of any of the preceding embodiments is selected from the group consisting of homopolymers of 1-ethenyl-2-pyrrolidinone, ethoxylated triglycerides, and polycarboxylate polymers.

In a twenty-sixth embodiment the at least one crystallization inhibiting additive of any of the preceding embodiments is selected from the group consisting of: alpha-cyclodextin; polyethylene glycols and ethers thereof salts of polycarboxylic acids, sodium salts of lignosulfonate acids, alkali lignin reaction products with disodium sulfite and formaldehyde, acrylic copolymers, alcohol initiated EO-BO polymers, sodium arylsulfonates, fatty acids, polyarylphenol alkoxylates, vinyl, acetate homopolymers, seed oils, sodium alkylaminopropionatess poly(4-ammonium styrene sulfonic acid), pigmentary synergist agents for dispersants, alkoxylated diamines, alcohol ethoxylates and polyoxyethylene sorbitan monofatty acids.

In a twenty-seventh embodiment, the at least one crystallization inhibiting additive of any of the preceding embodiments is present in at least about 1, 2, 3, 4, 5, 6, 7, 8, 9, or 10 wt. % In the formulation, more specifically between about 2 wt. % and about 8 wt. %, and more specifically about 5 wt. %.

In a twenty-ninth embodiment, wherein the formulation of any of the preceding embodiments is diluted in water to between about 0.1, 0.2, 0.3, 0.4, 0.5, 0.6, 0.7, 0.8, 0.9, or 1.0 wt. % of the at least one crystallization inhibiting additive, more specifically between about 0.2 wt. % and about 0.8 wt. % and more specifically about 0.5 wt. %.

### BRIEF DESCRIPTION OF THE FIGURES

The features of this disclosure, and the manner of attaining them, will become more apparent and the disclosure itself will be better understood by reference to the following description of embodiments of the disclosure taken in conjunction with the accompanying drawings.

FIG. 1 shows photographic images of samples in duplicate vials from the examples described below, which contain approximately 4 wt. % nitrapyrin, 6 wt. % Dowanol DPM, 0.5 wt. % crystallization inhibitor additive, and 89.5 wt. % deionized (“DI”) water.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate an exemplary embodiment of the disclosure, in one form, and such exemplifications are not to be construed as limiting the scope of the disclosure in my manner.

### DETAILED DESCRIPTION

(Trichloromethyl)pyridine compounds useful in the formulations and compositions of the present disclosure include compounds having a pyridine ring which is substituted with at least one trichloromethyl group and mineral acid salts thereof. Suitable compounds include those containing chlorine or methyl substituents on the pyridine ring in addition to a trichloromethyl group, and are inclusive, of chlorination products of methyl pyridines such as lutidine, collidine and picoline. Suitable salts include hydrochlorides, nitrates, sulfates and phosphates. The (trichloromethyl)pyridine compounds useful in the practice of the present disclosure are typically oily liquids or crystalline solids dissolved in a solvent. Other suitable compounds are described in U.S. Pat. No. 3,135,594. A preferred (trichloromethyl) pyridine, is 2-chloro-6-(trichloromethyl) pyridine, also known as nitrapyrin, and the active ingredient of the product N-SERVE™. (Trademark of Dow AgroSciences LLC).

Examples of typical polar solvent which can be used to dissolve crystalline (trichloromethyl)pyridine compounds include, but are not limited to: glycol derivatives such as ethylene glycol mono- and dialkyl ethers; dipropylene glycol monomethyl ether, dipropylene glycol monoethyl ether, diethylene glycol monomethyl ether, diethylene glycol monoethyl ether; esters of glycol derivatives such as the acetate ester of the n-butyl, propyl, ethyl, or methyl ether of diethyleneglycol and the acetate ester of the n-butyl, propyl, ethyl, or methyl ether of dipropylene glycol; ketones such as acetone, methyl ethyl ketone, diethyl ketone; cyclic alkyl carbonates such as ethylene carbonate and propylene carbonate; and methyl 5-(dimethylamino)-2-methyl-5-oxopentanoate, and derivatives thereof.

In general, the amount of solvent employed, if desired, is typically from about 40, preferably from about 50 to about 75, preferably to about 60 weight percent, based on the total weight of a (trichloromethyl) pyridine/solvent solution. The amount of (trichloromethyl)pyridine within a (trichloromethyl)pyridine/solvent solution is typically from about 20, preferably from about 30 to about 60, preferably to about 40 weight percent, based on the weight of a (trichloromethyl) pyridine/solvent solution. In some embodiments of the present disclosure, nitrapyrin technical can be used in the exemplary formulations. Nitrapyrin technical comprises about 90% to about 100% pure nitrapyrin depending on the impurity level. Therefore, in some embodiments the amount of solvent employed might be about 0% to about 10%, while the amount of nitrapyrin technical might be about 90% to about 100% pure.

Other conventional additives may also be incorporated into the formulation such as emulsifiers, dispersants, thickeners, biocides, pesticides, salts and film-forming polymers.

Dispersing and emulsifying agents include condensation products of alkylene oxides with phenols and organic acids, alkyl aryl sulfonates, polyoxyalkylene derivatives of sorbitan esters, complex ether alcohols, mahogany soaps, lignin sulfonates, polyvinyl alcohols, and the like.

The presence of a (trichloromethyl)pyridine compound suppresses the nitrification of ammonium nitrogen in the soil or growth medium, thereby preventing the rapid loss of ammonium nitrogen originating from nitrogen fertilizers, organic nitrogen constituents, or organic fertilizers and the like.

The enhanced nitrification inhibitor compositions of the present disclosure can be applied in any manner which will benefit the crop of interest. In one embodiment, the enhanced nitrification inhibitor compositions are applied to growth mediums in a band or row application. In another embodiment the compositions are applied to or throughout the growth medium prior to seeding or transplanting the desired crop plant. In yet another embodiment, the compositions can be applied to the root zone of growing plants.

Additionally, the compositions can be applied with the application of nitrogen fertilizers. The composition can be applied prior to, subsequent to, or simultaneously with the application of fertilizers.

Alternatively, if desired, the compositions, of the present disclosure can be incorporated into the soil directly upon application.

The soil may be prepared in any convenient fashion with the nitrification inhibitor compositions of the present disclosure, including mechanically mixed with the soil; applied to the surface of the soil and thereafter dragged or diced into the soil to a desired depth; or transported into the soil such as by injection, spraying, dusting or irrigation. In irrigation applications, the nitrification inhibitor compositions may be introduced to irrigation water in an appropriate amount in order to obtain a distribution of the (trichloromethyl)pyridine compound(s) to the desired depth of up to 6 inches (15.24 cm).

Additionally, the nitrification inhibitor compositions of the present disclosure can be combined or used in conjunction with pesticides, including arthropodicides, bactericides, fungicides, herbicides, insecticides, miticides, nematicides, nitrification inhibitors such as dicyandiamide, urease inhibitors such as N-(n-butyl) thiophosphoric triamide, and the like or pesticidal mixtures and synergistic mixtures thereof. In such applications, the nitrification inhibitor dry fertilizer compositions of the present disclosure can be mixed or blended with the desired pesticide(s) or they can be applied sequentially.

Exemplary herbicides include, but are not limited to, acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron methyl, nicosulfuron, paraquat, pendimethalin, picloram, primisulfuron, propoxycarbazone, prosulfuron, pyraflufen ethyl, rimsulfuron, simazine, sulfosulfuron, thifensulfuron, topramezone, tralkoxydim, triallate, triasulfuron, tribenuron, triclopyr, trifluralin, 2,4-D, 2,4-D amine, 2,4-D ester and the like.

Exemplary insecticides include, but are not limited to, 1,2 dichloropropane, 1,3 dichloropropene, abamectin, acephate, acequinocyl, acetamiprid, acethion, acetoprole, acrinathrin, acrylonitrile, alanycarb, aldicarb, aldoxycarb, aldrin, allethrin allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A & B, crufomate, cryolite, cyanofenphos, cyanophos, cyanthoate, cyclethrin, cycloprothrin, cyenopyrafen, cyflumetofen, cyfluthrin, cyhalothrin, chexatin, cypermethrin, cyphenothrin, cyromazine, cythioate, d-limonene, dazomet, DBCP, DCIP, DDT, decarbofuran, deltamethrin, demephion, demephion O, demephion S, demeton, demeton methyl, demeton O, demeton O methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenohtiocarb, fenoxacrim, fenoxycarb, fenpirithrin, fenpropathrin, fenpyroximate, fenson fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton methyl, oxydeprofos, oxydisulfoton, paradichlorobenzene, parathion, parathion methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp′ DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos methyl, quinothion, quantifies, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vamidothion, vaniliprole, vaniliprole, XMC, xylylcarb, zeta cypermethrin and zolaprofos.

Additionally, any combination of the above pesticides can be used. Additionally, Rynaxypyr™, a new anthranilic diamide (Chlorantraniliprole) crop protection chemistry from duPont with efficacy in controlling target pests can be used.

The following examples are provided to illustrate the present invention. The examples are not intended to limit the scope of the present invention and they should not be so interpreted. Amounts are in weight parts or weight percentages unless otherwise indicated.

### EXAMPLES

Some of the experiments disclosed herein were designed to simulate or resemble tank-mix dilution steps used in the actual agricultural applications. In particular, samples of nitrification inhibitors, polar solvents, additives, and water were prepared at concentrations substantially similar to many commercially used tank-mix dilutions (at nitrification inhibitor concentrations of 4 wt. %, 1 wt. %, and 0.4 wt. %). Samples of the diluted formulations were prepared in lab vials, the vials were photographed, the amount of crystal present in the vial was calculated, and the amount of crystal present was compared to control samples without additives present. Three water soluble polar solvents: Dowanol DPM; DV-Solve 1059; and Jeffsol AG 1555 were selected for study. These three polar solvents exhibit greater than 40% nitrapyrin solubility and greater than about 10% water solubility, up to about 100% water solubility.

At 4 wt. % nitrapyrin concentration in aqueous tank-mix dilutions of a Dowanol DPM formulation of nitrapyrin, two additives (Agrimer 30 and Hydroplat D) completely inhibited all crystallization of nitrapyrin for 5 days. Two other additives (Hydroplat 3204 and Hydroplat 44) were successful in one of the two duplicates that were prepared and tested (about 2 days). There were an additional 35 additives that reduced, but did not completely inhibit the amount of nitrapyrin crystals in the vials.

DOWANOL™ DPM glycol ether, CH₃O[CH₂CH(CH₃)O]₂H, is a mid-to slow evaporating solvent. This hydrophilic solvent has 100% water solubility and its intermediate evaporation rate allow it to be used in a potentially wider range of systems than many other solvents.

Commercial nitrapyrin liquid formulations include aromatic solvents such as, for example, xylene, 1,2,4-trimethylbenzene, and cumene. The incentive to switch from traditional organic solvents, such as the Aromatic line (for example Solvesso solvents from ExxonMobil), to these polar solvents include: (1) new nitrification inhibitor formulations with higher NI loading (≧35 wt. % vs. current about 20 wt. %); (2) the selected polar solvents may, in some embodiments, be more environmentally-friendly (green, biodegradable, and/or renewable); and (3) successful inhibition of nitrapyrin crystallization in the selected polar solvents may lead to a better understanding of the fundamental mechanism of a polymer stabilization effect upon tank-mix dilutions.

In some embodiments, the inventive formulations include any liquid compositions comprising (a) at least one solid agricultural active ingredient dissolved in at least one water-soluble, polar solvents and (b) at least one crystallization inhibiting additive used to prevent or inhibit agricultural active crystal formation upon forming aqueous tank-mix dilutions. In some embodiments, the agricultural active ingredient dissolved in the at least one water soluble polar solvent is a nitrification inhibitor, such as, for example, nitrapyrin.

Formulations were evaluated for their ability to inhibit crystallization of nitrapyrin in water-soluble polar solvents diluted with aqueous solution. In order for the experiments to substantially mimic tank-mix dilutions, the steps below were followed to prepare laboratory formulations. All concentrations are listed, as weight percent, unless otherwise noted.

Source solutions for each additive were prepared in deionized (“DI”) water at 0.5% additive concentration. The solutions were imaged for initial cloudiness or crystallization. Manual observations on the appearance of the solutions were recorded.

Source solutions containing nitrapyrin dissolved in each polar solvent were prepared at 40 wt. % nitrapyrin (or 4-10 wt. % nitrapyrin for lower concentration samples). These samples were prepared by heating the nitrapyrin to about 70° C. (above the melting temperature, which is 63° C.) and mixed as a liquid with the polar solvents. The final solutions were liquid at room temperature.

Separate aqueous additive solutions were then prepared and added to vials on an 8×12 HTR plate using an automated liquid handler at 720 μL per vial.

The polar solvent solutions which included nitrapyrin were then added to the aqueous additive solutions using an automated liquid handler at 80 μL. The HTR plate was then shaken by hand for about 30 seconds.

After about 1 hour and after about 1 day, the samples were examined manually to determine if any of the samples included crystallized nitrapyrin.

After 2 days, the samples were centrifuged for 10 minutes at 3000 rpm. Manual observation oi the vials was repeated and all of the vials were imaged using a high-resolution camera.

The samples were calibrated for accurate mass delivery prior to mixing of the formulations, except for the additives (only a few calibration curves were used due to the large number of additives and the curve selection was based on visual observation of viscosity). Samples that included final concentrations of nitrapyrin of: (1) 0.4 wt. % nitrapyrin (made with a source concentration of 4 wt. % nitrapyrin); and (2) 4 wt. % nitrapyrin (made with a source concentration of 40 wt. % nitrapyrin, which allowed crystallization to be observed more easily) were examined. The mixtures were observed at various time points over 1-48 hours to determine whether crystallization had occurred. Manual observations of crystallization were made at after about 1 hour and after about 1 day after sample preparation. Images were taken of the vials at about 2 days after sample preparation and after centrifugation. All image analysis results in the experiments were based on post-centrifugation vials that were 2 days old, unless otherwise stated.

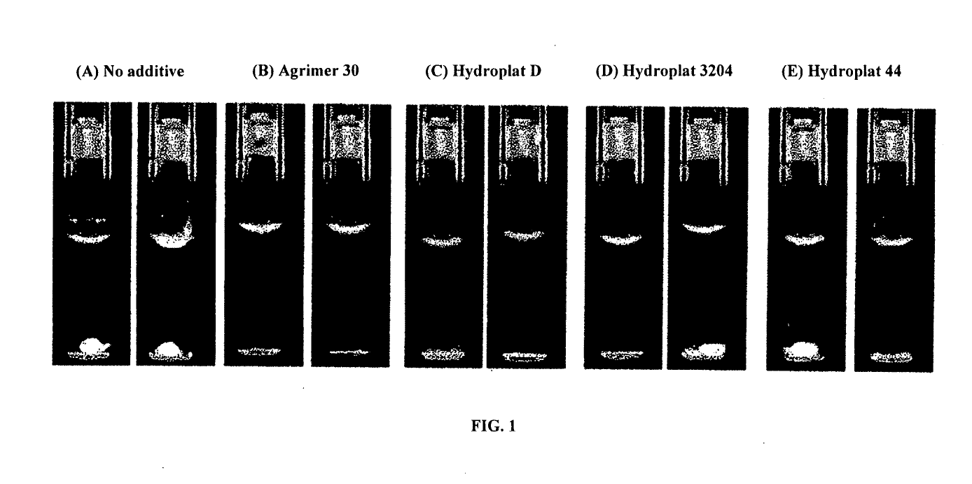

Referring now to FIG. 1, photographic images, of samples, which include approximately 4 wt. % nitrapyrin, 6 wt. % Dowanol DPM 0.5 wt. % crystallization inhibitor additive, and 89.5 wt. % DI water are shown. The duplicate vials in FIG. 1A include no crystallization inhibitor additive; the duplicates in FIG. 1B include crystallization inhibitor additive Agrimer 30; the duplicates in FIG. 1C include crystallization inhibitor additive Hydroplat D; the duplicates in FIG. 1D include crystallization inhibitor additive Hydroplat 3204; and the duplicates in FIG. 1E include crystallization inhibitor additive Hydroplat 44.

Crystal inhibition was defined by calculating the percentage of white particulate material present in each vial. Software used to identify pixels as either black or white. White particulates represent crystal formation. The area of white pixels was directly correlated with the amount of crystals in the vial.

In some embodiments in which the crystallization inhibitor additive containing compositions reduced crystallization, the samples had a percentage of white pixels (corresponding amount of crystals) that was less than the average percentage of white pixels found in the crystallization inhibitor additive-free control, minus the standard deviation of the percentage white pixels of the control (i.e., white pixel percentage in vials with crystal inhibition additives<average white pixel percentage in control−1 SD of control). Samples that were calculated to have a percentage of white crystals less, than the average of the control minus one standard deviation were then evaluated visually to look for any sign of crystal formation.

Using this assay, a total of 39 additives (shown in Table 1) were found to either inhibit or reduce the formation of crystals of nitrapyrin in a 4 wt. % nitrapyrin, 6 wt. % Dowanol DPM, 0.5 wt. % crystal inhibitor additive, and 89.5 wt. % water system as compared to the control samples. As shown in FIG. 1 two additives (Agrimer 30 and Hydroplat D) completely inhibited all crystallization of nitrapyrin (for about 5 days) and two other additives (Hydroplat 3204 and Hydroplat 44) were successful in inhibiting all crystallization of nitrapyrin in one of the two duplicate test samples that were prepared in the Examples (for about 2 days).

In some embodiments the crystallization inhibitor, can be added to concentrate formulations that include Dowanol DPM and nitrapyrin in order to prevent crystallization of nitrapyrin in tank-mix dilutions for at least 24 hours. None of the putative crystallization inhibitors which, were tested completely inhibited the crystallization of nitrapyrin at lower concentrations (e.g. tank mixes that included 0.4 wt. % and 1 wt. % of nitrapyrin). At the lower concentrations of nitrapyrin, quantitative evaluation of the amount of crystals formed was not possible. Success in inhibiting nitrapyrin crystallization in sample that included low levels of nitrapyrin was determined on a pass (no crystals) or fail (crystals) basis.

TABLE 1
Additives identified as crystal inhibitors.

| | Trade Name of | |
|---|---|---|
| | Putative Crystalliza- | |
| Additive | tion Inhibitor | |
| Number | (Additive) | Chemistry of Additive |
| 1 | Agrimer 30 | 1-ethenyl-2-pyrrolidinone, |
| | | homopolymer |
| 2 | Agrimer AL 22 | 1-ethenyl-2-pyrrolidinone, |
| | | homopolymer |
| 3 | ALCOGUARD 4000 | acrylic copolymer |
| 4 | ALCOGUARD | acrylic copolymer |
| | 4000-D | |
| 5 | ALCOSPERSE 408 | salt of polycarboxylic acid |
| 6 | ALCOSPERSE | acrylic copolymer |
| | 602-ND | |
| 7 | — | alpha-cyclodextrin |
| 8 | EOBO 775.15 | ethylene oxide 12, butylene |
| | | oxide 10 C10 chain |
| 9 | Hart SXS | sodium xylene sulfonate |
| 10 | Hydroplat 100 | polycarboxylate polymer |
| 11 | Hydroplat 3204 | polycarboxylate polymer |
| 12 | Hydroplat 44 | polycarboxylate polymer |
| 13 | Hydroplat 65 | ethoxylated triglyceride |
| 14 | Hydroplat D | ethoxylated triglyceride |
| 15 | Industrene 106 | oleic acid |
| 16 | Kraftsperse | sulfomethylated lignosulfonic |
| | EDF-350 | acid, sodium |
| 17 | Hydroplat P62 | ethoxylated triglyceride |
| 18 | Soprophor S25 | polyarylphenol ethoxylate |
| 19 | Agrimer 3E | 1-ethenyl-2-pyrrolidinone, |
| | | homopolymer |
| 20 | Agrimer 31 | 1-ethenyl-2-pyrrolidinone, |
| | | homopolymer |
| 21 | Hydroplat 1080 | polycarboxylate polymer |
| 22 | Hydroplat 188A | polycarboxylate polymer |
| 23 | Hydroplat 88 | ethoxylated triglyceride |
| 24 | Mirataine JCHA | sodium alkylaminopropionate |
| 25 | PEG 10K | polyethylene glycol |
| 26 | — | poly(4-ammonium styrene |
| | | sulfonic acid) |
| 27 | Polyco 2152 | vinyl acetate homopolymer |
| 28 | Polyfon H | lignosulfonic acid, sodium |
| 29 | Polyfon O | lignosulfonic acid, sodium |
| 30 | Polyfon T | lignosulfonic acid, sodium |
| 31 | Pureco 76 | coconut oil |
| 32 | REAX 83A | alkali lignin reaction products |
| | | w/disodium sulfite and formaldehyde |
| 33 | REAX 85A | alkali lignin reaction products |
| | | w/disodium sulfite and formaldehyde |
| 34 | REAX 907 | alkali lignin reaction products |
| | | w/disodium sulfite and formaldehyde |
| 35 | REAX 910 | alkali lignin reaction products |
| | | w/disodium sulfite and formaldehyde |
| 36 | Solsperse 5000 | pigmentary synergist agent for |
| | | dispersants |
| 37 | Span 20 | polyoxyethylene sorbitan |
| | | monopalmitate |
| 38 | Tetronic 304 | alkoxylated diamine |
| 39 | Toximul TDA-6 | tridecyl alcohol-[EO]₆ |

The samples tested included approximately 4 wt. % nitrapyrin, 6 wt. % polar solvent, 0.5 wt. % additive, and 89.5 wt. % water. Tested, in duplicate Agrimer 30 and Hydroplat D shows what appears to be complete inhibition of nitrapyrin crystallization. The additives HYDROPLAT 3204 and HYDROPLAT 44 successfully inhibited crystallization in one of the two duplicate samples tested. Note that these additives successfully inhibited crystallization only in the presence of the polar solvent Dowanol DPM.

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

1. An agricultural formulation, comprising:
at least one non-aromatic polar solvent;
at least one inhibitor of nitrification, wherein the at least one inhibitor of nitrification is substantially dissolved in the at least one non-aromatic polar solvent; and at least one crystallization inhibiting additive, wherein the crystallization inhibiting additive reduces crystallization of the at least one inhibitor of nitrification when the formulation is added to water.

2. An aqueous agricultural composition comprising the formulation according to claim 1 and water.

3. The formulation according to claim 1, wherein the at least one non-aromatic polar solvent is selected from the group consisting of: a glycol ether, propylene carbonate, and methyl 5-(dimethylamino)-2-methyl-5-oxopentanoate.

4. The formulation according to claim 1, wherein the at least one inhibitor of nitrification comprises nitrapyrin.

5. The formulation according to claim 4, wherein the nitrapyrin is between about 0.1 wt. % and about 50 wt. % of the formulation.

6. The formulation according to claim 4, wherein the nitrapyrin is between about 30 wt. % and about 40 wt. % of the formulation.

7. The aqueous agricultural composition according to claim 2, wherein the at least one inhibitor of nitrification comprises nitrapyrin.

8. The aqueous agricultural composition according to claim 7, wherein the nitrapyrin is between about 0.1 wt. % and about 5 wt. % of the formulation.

9. The aqueous agricultural composition according to claim 7, wherein the nitrapyrin is between about 0.4 wt. % and about 4 wt. % of the formulation.

10. The formulation according to claim 1, wherein the at least one crystallization inhibiting additive comprises a polymer substantially dissolved in the formulation.

11. The formulation according to claim 10, wherein the polymer comprises a homopolymer of 1-ethenyl-2-pyrrolidinone.

12. The formulation according to claim 1, wherein the at least one crystallization inhibiting additive is selected from the group consisting of: homopolymers of 1-ethenyl-2-pyrrolidinone, ethoxylated triglycerides, and polycarboxylate polymers.

13. The formulation according to claim 1, wherein the at least one crystallization inhibiting additive is selected from the group consisting of: alpha-cyclodextrin, polyethylene glycols or ethers thereof, salts of polycarboxylic acids, sodium salts of lignosulfonate acids, alkali lignin reaction products with disodium sulfite and formaldehyde, acrylic copolymers, alcohol initiated EO-BO polymers, sodium arylsulfonates, fatty acids, polyarylphenol alkoxylates, vinyl acetate homopolymers, seed oils, sodium alkylaminopropionates, poly(4-ammonium styrene sulfonic acid), pigmentary synergist agents for dispersants, alkoxylated diamines, alcohol ethoxylates and polyoxyethylene sorbitan monofatty acids.

14. The formulation according to claim 1, wherein the at least one crystallization inhibiting additive is present at between about 2 wt. % and about 8 wt. %.

15. The aqueous agricultural composition according to claim 2, wherein the at least one crystallization inhibiting additive is present at between about 0.2 wt. % and about 0.8 wt. %.

16. A method for inhibiting or reducing crystal formulation of an agricultural formulation, comprising the step of:
adding at least one crystallization inhibiting additive to a formulation comprising: at least one non-aromatic polar solvent;
at least one inhibitor of nitrification, wherein said at least one inhibitor of nitrification is substantially dissolved in the at least one non-aromatic polar solvent, and
wherein the crystallization inhibiting additive reduces crystallization of the at least one inhibitor of nitrification when the formulation is diluted in water.

17. The method according to claim 16, wherein the at least one non-aromatic polar solvent is selected from the group consisting of: a glycol ether, propylene carbonate, and methyl 5-(dimethylamino)-2-methyl-5-oxopentanoate.

18. The method according to claim 16, wherein the at least one inhibitor of nitrification comprises nitrapyrin.

19. The method according to claim 18, wherein the nitrapyrin is between about 0.1 wt. % and about 50 wt. % of the formulation.

20. The method according to claim 18, wherein the nitrapyrin is between about 30 wt. % and about 40 wt. % of the formulation.

21. The method according to claim 16, wherein the formulation is diluted in water to between about 0.1 wt. % and about 5 wt. % of nitrapyrin.

22. The method according to claim 16, wherein the formulation is diluted in water to between about 0.4 wt. % and about 4 wt. % of nitrapyrin.

23. The method according to claim 16, wherein the at least one crystallization inhibiting additive comprises a polymer substantially dissolved in the formulation.

24. The method according to claim 23, wherein the polymer comprises a homopolymer of 1-ethenyl-2-pyrrolidinone.

25. The method according to claim 16, wherein the at least one crystallization inhibiting additive is selected from the group consisting of: homopolymers of 1-ethenyl-2-pyrrolidinone, ethoxylated triglycerides, and polycarboxylate polymers.

26. The method according to claim 16, wherein the at least one crystallization inhibiting additive is selected from the group consisting of: alpha-cyclodextrin, polyethylene glycols or ethers thereof, salts of polycarboxylic acids, sodium salts of lignosulfonate acids, alkali lignin reaction products with disodium sulfite and formaldehyde, acrylic copolymers, alcohol initiated EO-BO polymers, sodium arylsulfonates, fatty acids, polyarylphenol alkoxylates, vinyl acetate homopolymers, seed oils, sodium alkylaminopropionates, poly(4-ammonium styrene sulfonic acid), pigmentary synergist agents for dispersants, alkoxylated diamines, alcohol ethoxylates and polyoxyethylene sorbitan monofatty acids.

27. The formulation according to claim 16, wherein the at least one crystallization inhibiting additive is present at between about 2 wt. % and about 8 wt. %.

28. The formulation according to claim 16, wherein the formulation is diluted in water to between about 0.2 wt. % and about 0.8 wt. % the at least one crystallization inhibiting additive.
